(19) United States
(12) Patent Application Publication
(10) Pub. No.: US 2026/0161702 A1
(43) Pub. Date: Jun. 11, 2026

(54) ITEM BUNDLE SEARCHING BASED ON IMAGE SEGMENTATION

(71) Applicant: eBay Inc., San Jose, CA (US)

(72) Inventors: Feng XIE, Shanghai (CN); Kun Yu, Shanghai (CN); Xiaojie Zang, Shanghai (CN); Jian Pan, Shanghai (CN); Weiting Yin, JiangYin City (CN); Gui Gong, Shanghai (CN); Keshun Deng, Shanghai (CN); Xiwei Huang, Shanghai (CN)

(21) Appl. No.: 18/971,560

(22) Filed: Dec. 6, 2024

(51) Int. Cl. G06F 16/538; G06F 16/583; G06T 7/12

(52) U.S. Cl. CPC G06F 16/538; G06F 16/583; G06T 7/12

(57) ABSTRACT

Systems, methods, and media are provided for separately searching a plurality of image segments in an image and displaying search results for each image segment on the same search results page. An input image may be uploaded to a search engine. An image segmentation technique and object recognition model are used to identify objects and extract image segments having the objects in the segmented image. A database search is performed for each image segment to identify search results for each image segment. The search results are generated for display on a search results page in groups. In some aspects, a first search results page may display the top ranked search results for each image segment in a group, and a second search results page may include the second ranked search results for each segment in a group.

### BACKGROUND

Search engines are often used to process input images to produce search results related to the input image. When an image is uploaded, search engines analyze the contents of input images by employing different methods of image processing to identify features within the images. These features help the search engine to match an input image with relevant search results. In many cases, the search results are displayed as lists. With this conventional list format, users may browse pages of search results until they find the search results they are looking for.

### SUMMARY

At a high level, aspects described herein relate to separately searching a plurality of image segments in an image and displaying search results for each image segment on the same search results page.

When users enter input images as queries at a search engine, search results can be provided based on image segments of the input image. That is, objects within the image can be identified and image segments having the objects can be extracted from input images and can be used to generate search results that are displayed in groups on a search results page, which allows users to navigate through the search results for separate searches on the same pages.

To do so, an input image (e.g., an image query) is received. These input images may be uploaded to a search engine. When an image is uploaded to the search engine, image segmentation may be performed on the image.

Image segmentation may be performed on the image to help identify objects within the image. For example, an image segmentation method may be used to divide the image into smaller segments by reducing background interference, which improves search accuracy. An object recognition model may be used to identify objects and extract image segments having the objects in the segmented image. Each image segment may be a portion of the input image and includes the object that identifies each image segment.

A database search may be performed for each image segment to identify search results for each image segment. The database search may be a separate reverse image search for each image segment. Each image segment may be used to query a database to determine if there are items in the database that match any of the image segments.

In some aspects, users may select the image segments for searching. The selected image segments may be used to perform a reverse image search against a database for each of the image segments to determine the search results. The determined search results are generated for display on a search results page in groups.

In some aspects, there may be multiple search results pages. For example, a first search results page may display the top ranked search results for each image segment in a group, and a second search results page may include the second ranked search results for each segment in a group.

This summary is intended to introduce a selection of concepts in a simplified form that is further described in the Detailed Description section of this disclosure. The Summary is not intended to identify key or essential features of the claimed subject matter, nor is it intended to be used as an aid in determining the scope of the claimed subject matter. Additional objects, advantages, and novel features of the technology will be set forth in part in the description which follows, and in part will become apparent to those skilled in the art upon examination of the disclosure or learned through practice of the technology.

### BRIEF DESCRIPTION OF THE DRAWINGS

The present technology is described in detail below with reference to the attached drawing figures, wherein:

FIG. 1 is an example operating environment in which the technology can be employed, in accordance with an aspect described herein;

FIG. 2 illustrates an example image segmentation engine suitable for use by aspects of the technology, in accordance with an aspect described herein;

FIG. 3 illustrates an example image segment determiner suitable for use by aspects of the technology, in accordance with aspects described herein;

FIG. 4 illustrates an example image searcher suitable for use by aspects of the technology, in accordance with aspects described herein;

FIG. 5 illustrates an example search results page generator suitable for use by aspects of the technology, in accordance with aspects described herein;

FIG. 6A illustrates an example first search results page generated by components of FIG. 1, in accordance with aspects described herein;

FIG. 6B illustrates an example second search results page generated by components of FIG. 1, in accordance with aspects described herein;

FIGS. 7-9 are example search methods, which can be performed by components of FIG. 1, in accordance with aspects described herein; and

FIG. 10 is an example computing device suitable for implementing the described technology, in accordance with an embodiment described herein.

### DETAILED DESCRIPTION

Image-based searching refers to the process of using a search engine to find information over a network, such as the internet, by entering image queries. In this method, users input an image into a search engine, and the search engine returns a list of items, which could include web pages, documents, images, goods or services for sale, videos, music, or other types of digital files that are considered relevant to the query.

Conventionally, the search engine processes a text-based query to understand its intent. This may involve parsing the query, correcting misspellings, and sometimes expanding the query using synonyms or related terms, a process known as query expansion. Many search engines maintain an extensive index of web pages and other online content. The processed query is used to search this index for matching results.

In many cases, search engines use ranking algorithms to sort the results based on various factors such as relevance, page quality, and the number of inbound links, among others. The sorted list of results is displayed to the user, usually with a title, a brief snippet of content, and the URL (uniform resource locator) of a landing page related to the item. The user can then click on the item to visit the webpages and access the information for which they were searching.

Image-based searching, sometimes referred to as “reverse image searching,” is a type of search where an image is used as the search query. In this method, users upload an image to a search engine, which then analyzes the image and returns a list of items that may include similar images or related information. The search engine may use various techniques like feature extraction, color histograms, and machine learning algorithms to identify patterns, shapes, and other characteristics within the image to further optimize the search results. For instance, some conventional search engines process the image to extract key features such as color distribution, texture, and shapes. The extracted features are used to search a database of indexed images for matches. Similar to text-based searches, the search engine ranks the results based on similarity metrics, and the ranked results are provided back to a user computing device.

Image-based searching is particularly useful when the user cannot adequately describe what they are looking for in text. For example, identifying a landmark or a piece of art is often easier with an image than with a textual description. Image-based searching can be beneficial for users who are looking for products but do not know the exact name or brand. They can simply upload a picture of the item to find similar products.

Further, image-based searching provides a rich contextual framework for queries. A single image can encapsulate a multitude of elements—such as colors, textures, lighting, and more—that would otherwise require extensive textual description to be input by a user. This visual complexity allows for more precise and nuanced search results.

Search techniques, including image-based searching, are integral to the technical function of the internet, primarily because of the sheer volume and diversity of content available online. The internet hosts billions of webpages, images, videos, and other forms of data across a vast network of servers. Without sophisticated search and ranking algorithms, it would be virtually impossible for users to find relevant information in this vast sea of content. As such, search and ranking techniques are critical to internet functioning, as it would not be possible for a user to sift through each of these results, necessarily relying on the search engine and its ability to identify and rank search results, instead.

However, one problem with image-based searching is that some images have multiple objects within the image, and search engines often do not identify individual objects within images. Instead, search engines often seek to identify the closest matching image to the image-based query as a whole, which may not be able to isolate and focus on individual segments of the image. For instance, a user may intend to search for a car headlight by taking a picture of the front aspect of the car. In this example, traditional search engines would seek to match the car, rather than identify results more tailored to the headlight. Continuing the example, individual objects such as a car headlight are often relatively far away from actual cars in the vector space. Thus, when searching databases using vector distances, such as conventional methods that employ KNN (K-nearest neighbor) database searching, many search results are often missed because search results are retrieved relative to the car image vector, and the headlight image vector may be too distant in the vector space for retrieval. Consequently, search results may be missed when searching images as a whole.

This problem is compounded when seeking to search more than one object in an image because, even if the search engine employs techniques (e.g., such as image segmentation) to recognize an object in an image, traditional search engines often only search one object and display results for that object. For example, a conventional search engine may identify objects within an input image, such as objects on a desk within a picture of an office. However, even when more than one object is identified (e.g., computer, printer, stapler, etc.), conventional search engines often only search a single object from the image and display search results related to that object (e.g., different types of computers or printers). As such, traditional search engines fail to perform separate database searches for more than one object in an input image and fail to display the search results for multiple objects on the same search results page.

Furthermore, traditional search engines often display search results for a single search, thus limiting their capability to provide relevant search results for more than one object in an image. For example, traditional search engines often display search results as a plain list of individual items. In other words, when the search results are displayed on traditional search engines, the search results are usually displayed by first listing different search results for one object before displaying search results for another object after a different search is executed. For example, if a user uploads an image of a car, and the user wants to see search results for both a windshield and a windshield wiper (e.g., both identified from the input image of the car), the search results page may display several search results for windshields in a plain list before displaying the search results for a windshield wiper (e.g., windshield wipers and windshields are not necessarily displayed together on the same search results page).

There are a few drawbacks to displaying search results from a single database search on a single search results page. For example, displaying search results for a single image segment on one search results page could increase page load times, especially if the search results include images, descriptions, reviews and/or other data that requires additional resources to load. Furthermore, this requires users to navigate back and forth between different items on different search results pages if one object dominates each search results page. Thus, the drawback results in the computer having to load multiple search results pages to display separate items.

To solve these problems, the disclosed technology identifies objects in an input image, extracts image segments of the identified objects, performs separate database searches on each image segment to identify separate sets of search results, and displays search results for each image segments on a search results page. To do this, the disclosed technology leverages any image segmentation technique, an object recognition model, similarity queries, and interactive item filtering. For example, an image segmentation method may be used to divide images into smaller segments using object identification (e.g., an object recognition model), which reduces background interference from other parts of the image to improve search accuracy. An object recognition model may be used to identify objects and extract image segments having those objects in the segmented image. For instance, the object recognition model may identify edges of an object, and segments of the image corresponding to the object edges may be extracted, thereby removing the remainder of the image not identified as part of the object. Thus, each image segment may be a portion of the input image and includes the object that identifies each image segment.

A database search may be performed using each image segment (e.g., image segments with at least one corresponding match to the search engine's database) to identify a separate set of search results for each image segment. It will be understood that a database search, as described herein, may include searching a single database or multiple disparate databases connected across a network. In an aspect, the database search may be a separate reverse image search for each image segment. Other search techniques may be used, such as a text-based search using text describing the image or the image segment. In general, each image segment may be used to query a search engine database to determine if there are potential search results in the database that matches any of the image segments.

In addition, users may be able to select a portion of the image segments identified from an image for searching. For example, the image segments extracted from the image can be presented at a display. The user may select one or more of the image segments from a portion of identified image segments provided for display. The selected image segments may be separately searched to identify a separate set of search results for each selected image segment. The determined search results are generated for display on a search results page.

The disclosed technology may display the search results on a search results page as a set of search results (e.g., two or more search results corresponding to the selected image segments that were separately searched). As such, a user may be presented with a search results page having one or more search results selected from each separate search of the image segments. For instance, one or more search results for a headlight and one or more search results for a fender may be displayed on the same search results page. There may be multiple search results pages. For example, a first search results page may display the top ranked search results for each image segment in a group, and a second search results page (e.g., hyperlinked to the first search results page) may include the second ranked search results for each segment in a group.

Advantageously, this technique and others that will be further described, help solve many problems inherent in conventional search engines employing image-based search methods. For instance, by utilizing an image segmentation method to identify image segments based on objects within the image, the present disclosure solves the issues associated with search engines searching the image as a whole. Moreover, instead of traditional search engines identifying the object at a macro level (e.g., searching the entire image), the present disclosure identifies the object at a more granular level by identifying and extracting image segments from the image. In this way, a database search may be performed on each image segment instead of the image as a whole, which results in more accurate identification and return of search results by the search engine. Thus, there is a better chance that search results representing the intent of the user submitting the image query may be generated and displayed.

Techniques presented herein also improve traditional search engines by performing separate database searches for each identified object in an input image. For example, while conventional search engines often only search a single object from the image and display search results related to that object, a search engine of the present disclosure may perform separate database searches on each identified image segment to identify a set of search results for each image segment. In this way, more search results may be identified and displayed, providing a variety of search results that includes multiple objects instead of a single object. This reduces the number of pages that a computer loads when employing a search engine, since, as noted above, traditional methods often required computers to load a separate search page for separate searches.

Additionally, the approach of displaying the search results on a search results page as a set of search results including two or more search results is a technical improvement of the conventional displaying method of traditional search engines. For instance, by displaying a set of search results corresponding to each searched image segment solves the issues associated with displaying search results as plain lists between which a computer must navigate. For example, according to the present disclosure, if a user uploads an image of a car, and the user wants to see search results for both a windshield and a windshield wiper, the search results page may display search results including both windshield wipers and windshields displayed together on the same search results page. Thus, the technology may return search results for both a windshield and a windshield wiper, which previously may not have been identified in the search and returned, since traditional search engines performing single searches would have focused on the car or only a single component of it. For instance, a traditional search may return items identified in the search space for the car, which may be too distant from the search space associated with a wiper, and thus, wipers may not be returned at all.

Further, techniques provided herein can help improve some aspects of the computing device, itself. For instance, by displaying search results for separate image segments on the same page as a set of search results, page load times may be decreased due to the conciseness of the search results being displayed. Moreover, by searching multiple image segments of an image in the same operation, the present disclosure may decrease computational costs. For example, when a traditional search engine searches a single object in an image, a user may need to run a subsequent search (e.g., either image- or text-based) to receive search results that better match the intent on the user in submitting the original query. For instance, traditional search engines perform a search and display search results for that particular search. When a second separate search is performed, new search results for the second search are loaded. However, by performing separates searches and displaying the results of separate searches on the same page, the number of pages loaded is reduced. Further, more accurate search results can be efficiently identified and returned, thereby lowering the number of searches that a user submits to the search engine. Based on this, the search engine described herein receives fewer queries, since users are more likely to be provided and find the search results relevant to that particular user. Accordingly, there is more computational processing power available for the search engine to perform other tasks. Further, overall system latency may be reduced, as the reduction in the response time experienced from fewer transmitted search results (e.g., more concise search results) allows for faster processing of each user query.

Moreover, many of the techniques that are described are not well-understood, routine, or conventional in relevant technological fields. For instance, it's believed that identifying objects in an input image, extracting image segments having the identified objects, performing separate database searches on each image segment to identify separate sets of search results, and displaying search results for each image segment on a search results page, is not a process readily employed by conventional search engines.

It will be realized that the methods previously described are only examples that can be practiced from the description that follows, and they are provided to more easily understand the technology and recognize its benefits. Additional examples are now described with reference to the figures.

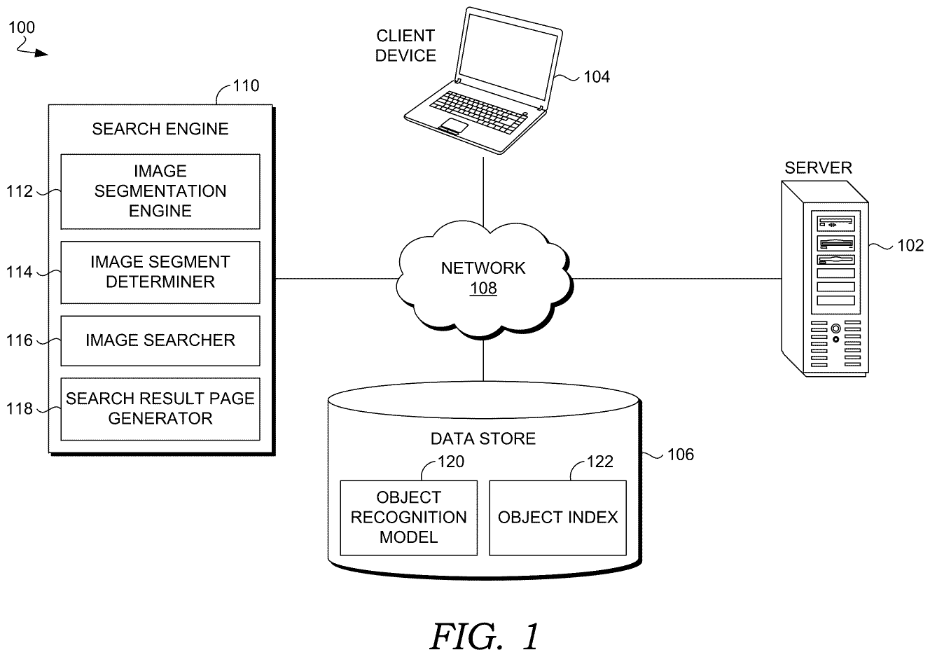

With reference now to FIG. 1, an example operating environment 100 in which aspects of the technology may be employed is provided. Among other components or engines not shown, operating environment 100 includes server 102, client device 104, and data store 106. Each of which is illustrated communicating across network 108 to search engine 110.

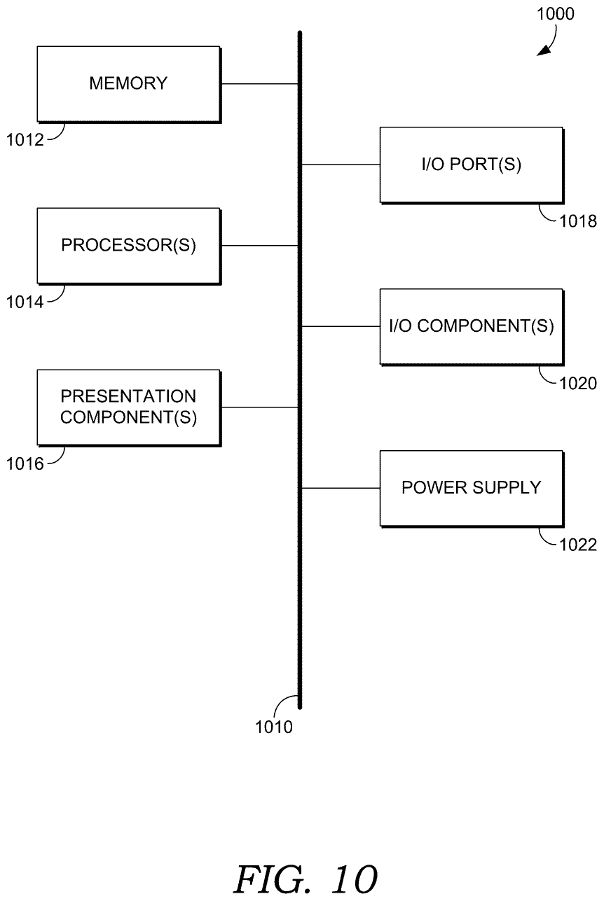

Generally, server 102 is a computing device that implements functional aspects of operating environment 100 to facilitate providing search results for an image query. One suitable example of a computing device that can be employed as server 102 is described as computing device 1000 with respect to FIG. 10. In implementations, server 102 represents a back-end or server-side device. Server 102 may receive an image query from client device 104, and identify search results for the image query, which server 102 may provide to client device 104 in response to receiving the image query.

Client device 104 is generally a computing device that can receive an image query from a user and provide the image query to server 102 for identification of search results. In some aspects, functions for identifying search results may be executed locally at client device 104. Client device 104 may present the search results, or other information, to the user. One suitable example of a computing device that can be employed as client device 104 is described as computing device 1000 with respect to FIG. 10. In implementations, client device 104 is a client-side or front-end device. In addition to server 102, client device 104 may implement functional aspects of operating environment 100 to provide search results or other information to a user. It will be understood that some implementations of the technology will comprise either a client-side or front-end computing device, a back-end or server-side computing device, or both executing any combination of functions, some examples of which will be further described, to identify and provide search results, or other information, to a user.

Network 108 may include one or more networks (e.g., public network or virtual private network “VPN”) as shown with network 108. Network 108 may include, without limitation, one or more local area networks (LANs) wide area networks (WANs), or any other communication network or method.

Data store 106 generally stores information including data, computer instructions (e.g., software program instructions, routines, or services), or models used in embodiments of the described technologies. Although depicted as a single database component, data store 106 may be embodied as one or more data stores or may be in the cloud.

To generate search results, components of operating environment 100 may employ search engine 110, which uses image segmentation engine 112, image segment determiner 114, image searcher 116, and search results page generator 118 in this particular example. Search engine 110, image segmentation engine 112, image segment determiner 114, image searcher 116, and search results page generator 118 may include computer-readable instructions, and may be stored within data store 106 for use by components of operating environment 100.

Having identified various components of operating environment 100, it is again emphasized that any additional or fewer components, in any arrangement, may be employed to achieve the desired functionality within the scope of the present disclosure. Although the various components of FIG. 1 are shown with lines for the sake of clarity, in reality, delineating various components is not so clear, and metaphorically, the lines may more accurately be grey or fuzzy. Although some components of FIG. 1 are depicted as single components, the depictions are intended as examples in nature and in number and are not to be construed as limiting for all implementations of the present disclosure. The functionality of operating environment 100 can be further described based on the functionality and features of the previously listed components. Other arrangements and elements (e.g., machines, interfaces, functions, orders, and groupings of functions, etc.) can be used in addition to or instead of those shown, and some elements may be omitted altogether.

Further, many of the elements described in relation to FIG. 1, for instance, those described in relation to search engine 110, are functional entities that may be implemented as discrete or distributed components or in conjunction with other components, and in any suitable combination and location. Various functions described herein are being performed by one or more entities and may be carried out by hardware, firmware, or software. For instance, various functions may be carried out by a processor executing computer-executable instructions stored in memory. Moreover, the functions described in relation to FIG. 1 may be performed by server 102, client device 104, or a combination of both.

To identify and generate search results, client device 104 or server 102 may receive a search query for a search engine (e.g., search engine 110). A search query can be provided in any form, including text, images, or the like. As such, in some aspects, the search query is an image-based search query. In some aspects, client device 104 may provide the search query to server 102 to identify and generate search results using search engine 110, which can be provided back to client device 104 for presentation at a user interface. In some cases, server 102 can generate a search results page containing the search results and provide the search results page to client device 104 for display via a graphical user interface (GUI).

As part of identifying and generating search results or providing a search results page for display, server 102 can employ search engine 110. In general, search engine 110 identifies an image-based search query received from client device 104. The image-based search query may be an input image submitted to search engine 110. For example, a user can submit an image of a car as an input image to search engine 110. In this way, search engine 110 can identify objects in the input image, extract image segments of the identified objects, perform separate database searches on each image segment to identify separate sets of search results, and provide search results for each image segment on a search results page. In doing so, search engine 110 may employ image segmentation engine 112, image segment determiner 114, image searcher 116, and search results page generator 118

In general, image segmentation engine 112 identifies objects within an image and segments the image into image segments having one or more objects. To do so, image segmentation engine may use any image segmentation technique to segment the input image. For example, image segmentation engine 112 may use an object identification method to identify objects within the input image, such as an object identification method that employs object recognition model 120. In some aspects, object recognition model 120 (e.g., zero-shot model, fine-tuned model, etc.) may identify objects in the input image and the edges of those objects. By identifying specific objects in the input image and their edges, background interference may be reduced from other parts of the image by extracting out the identified objects. Reducing background interference (e.g., background information) may improve search accuracy and enhance the quality of the generated search results.

In some aspects, after utilizing object recognition model 120 to identify objects within the input image, image segmentation engine 112 may extract image segments having those objects in the segmented image (e.g., without background information). For example, the object recognition model may identify edges of an object, and segments of the image corresponding to the object edges may be extracted, thereby removing the remainder of the image not identified as part of the object. As such, each image segment may be a portion of the input image and includes the object that identifies each image segment. By utilizing an image segmentation method to identify image segments based on objects within the image, search engine 110 of the present disclosure solves the issues associated with traditional search engines that search the input image as a whole. As will be further described, in some aspects, an image segment may comprise more than one object, as some objects may have other objects embedded within them.

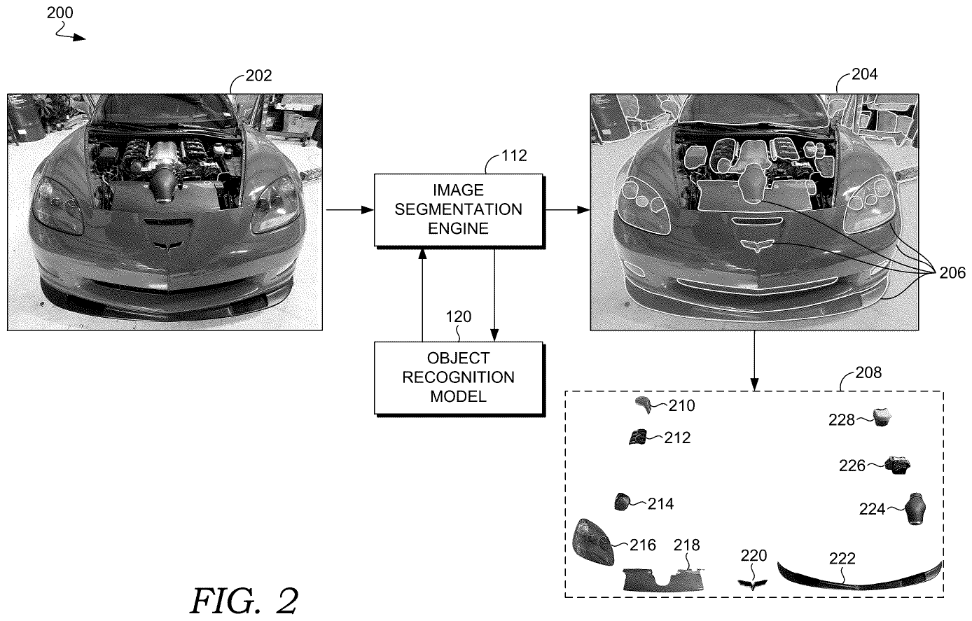

Referring now to FIG. 2, FIG. 2 illustrates an example of image segmentation engine 112 utilizing object recognition model 120 to identify objects and extract image segments having those objects in the segmented image (e.g., segmented image 204). An example image segmentation 200 is provided illustrating an input image 202 entered at search engine 110. In this example, input image 202 is an image of a front-end view of a car that contains multiple components and parts (e.g., objects within input image 202). The example of this input image 202 of a car is continued in several figures but is not meant to limit the applications of the technology. Instead, this example is given as an illustrative aid in understanding the context of the technology and some of its benefits.

In response to receiving input image 202, image segmentation engine 112 may employ any image segmentation technique on input image 202. For example, image segmentation engine 112 may leverage threshold-based segmentation, edge-based segmentation, region-based segmentation, clustering-based segmentation, artificial neural network-based segmentation (e.g., such as a convolutional neural network (CNN)), or any other type of image segmentation method to segment input image 202. In some aspects, image segmentation engine 112 may utilize an image segmentation technique to divide input image 202 into smaller segments using object recognition model 120 to identify objects in the image.

As such, image segmentation engine 112 of search engine 110 may employ object recognition model 120 to identify objects, and image segmentation engine 112 may extract image segments having those objects to generate segmented image 204. According to some aspects, object recognition model 120 may identify edges of an object, as illustrated by segmented image 204 using segmentation masks. For example, object recognition model may detect discontinuities in brightness or abrupt changes in pixel intensity, which characterize the boundaries (e.g., edges) of objects in input image 202.

By utilizing object recognition model 120 to identify edges of an object, image segmentation engine 112 may extract segments of input image 202 corresponding to the object edges. In doing this, image segmentation engine 112 may remove the remainder of input image 202 not identified as part of an object in the image (e.g., may remove the background information), and image segmentation engine 112 may isolate image segments from the input image (e.g., isolate different parts of the car). Thus, image segmentation engine 112 may segment input image 202 based on the objects in input image 202 to produce image segments 206, which can be seen in segmented image 204. The image segments 206 illustrate some object identified from the object recognition model 120 as examples, although other objects and combinations of objects may be identified.

According to examples, each of the image segments 206 may be a portion of input image 202 and may include the object that identifies each image segment 206. For example, segmented image 204 includes components and parts that identify each image segment 206 corresponding to the car in input image 202. As can be seen in box 208, each extracted image segment 206 is based on an object identified by object recognition model 120. For example, box 208 includes the following extracted image segments: side mirror 210, pistons 212, gasket 214, headlight 216, engine cover 218, emblem 220, fender 222, tube 224, alternator 226, and fluid container 228. As can be seen, each image segment 206 in segmented image 204 corresponds to and includes the object that was used by object recognition model 120 and image segmentation engine 112 to produce each image segment 206. In contrast to traditional search engines that identify an object at a macro level by searching the entire input image, the present disclosure identifies the object at a more granular level by identifying and extracting image segments from the image.

Turning back to FIG. 1, after search engine 110 identifies and extracts image segments using image segmentation engine 112 and object recognition model 120, search engine 110 may employ image segment determiner 114. In some aspects, image segment determiner 114 may determine the images segments that will be used when performing database searches (e.g., each image segment 206 of FIG. 2, for example) to identify a separate set of search results for each individual image segment. In general, image segment determiner 114 determines two or more image segments to query a search engine database. In an aspect, the image segment determiner 114 selects each of the extracted image segments provided by image segmentation engine 112 for searching. In an aspects, the image segment determiner selects a subset of two or more of the extracted images segments from image segmentation engine 112 for searching. For example, the images segment determiner 114 may select a subset of extracted images segments based on an image quality of each image segment. In some aspects, the image segment determiner may select a subset of the extracted images based on additional input received corresponding to the extracted image segments. For instance, the image segments may be presented at a display of computing device 104, and computing device 104 may receive a selection of two or more of the extracted image segments, e.g., via a user input. Based on receiving the inputs corresponding to the two or more extracted image segments, the image segment determiner 114 may select the two or more extracted images for searching.

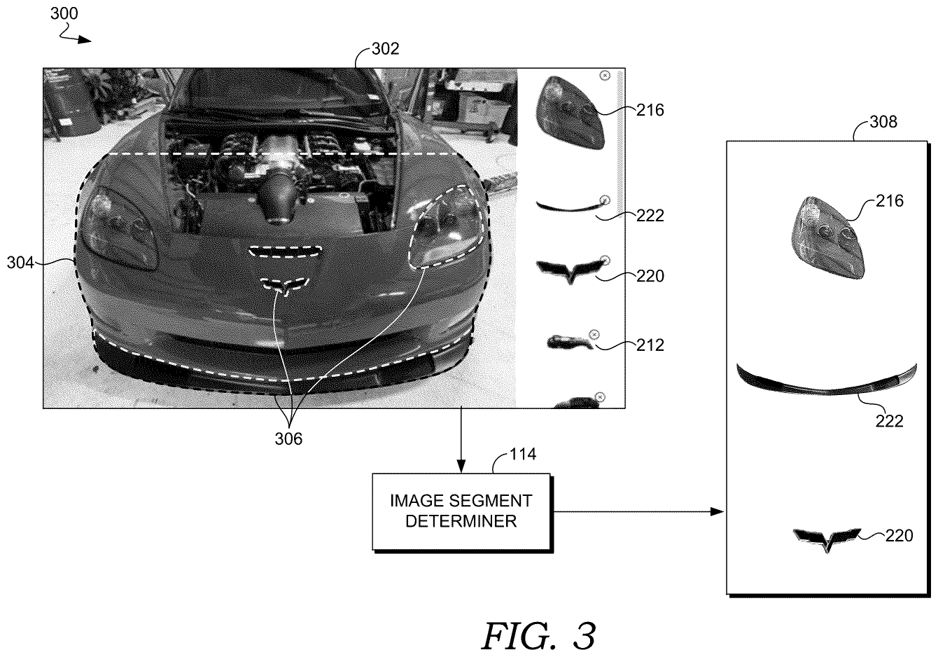

With reference now to FIG. 3, FIG. 3 provides an example illustration of search engine 110 employing image segment determiner 114. An example illustration 300 is provided. To provide a continued illustrated example, each image segment 206 identified and extracted in FIG. 2 may be selected for searching. In the illustration 300 provided in FIG. 3, an image 302 corresponding to the input image 202 is provided for display. In this example, object 304 and objects 306 have been identified. In this particular example, object 304 (a first object) comprises one or more of objects 306 (second object(s)). In this illustrated example, extracted image segments corresponding to the identified objects are presented for display, e.g., extracted images segments 212, 216, 220, 222, and so forth. It will be realized that the illustration 300 for providing extracted image segments is just an example. Other methods and arrangements for providing extracted image segments for display may be employed.

As noted, two or more of the extracted image segments may be selected via a user input. In essence, this may allow a user to select which of the identified objects they wish to search using the search engine 110. Using FIG. 3 as an example, a user input identifying three of the extracted image segments has been received. The three extracted image segments having received inputs correspond to extracted images segments 216, 220, and 222, as seen in 308. Thus, image segment determiner 114 may select the image segments 216, 220, and 222 and provide them to image searcher 116 for performing a search, as will be further described.

Accordingly, a subset of image segments selected from a plurality of image segments can be provided for searching to produce search results. In other words, at least a portion of the identified image segments may be provided for display at client device 104. When the identified image segments are provided for display, a selection of image segments from the portion of identified image segments provided for display may be received at client device 104. In some cases, the selection may be a first image segment and a second image segment, and a database search may be performed for each image segment of the selection, as will be discussed with respect to image searcher 116.

In the example illustrated in FIG. 3, the input image (e.g., input image 202 of the car) is presented at display 302 along with image segments. For example, headlight 216, fender 222, emblem 220, and piston 212 were identified by image segment determiner 114 to have at least one matching item (e.g., a search result). In some examples where many image segments are identified by image segment determiner 114, a user may scroll through all of the identified image segments to determine which image segments that the user wants searched. In the example depicted in FIG. 3, the user selected headlight 216, fender 222, and emblem 220 (e.g., as illustrated in box 308) for searching.

As can be seen in the example illustrated in FIG. 3, one image segment may comprise another image segment. For example, the image segment of the front end of the car (e.g., first image segment 304) comprises other image segments (e.g., second image segments 306), such as the headlight, fender, and emblem. Thus, image segments identified by image segment determiner 114 can comprise other image segments.

With reference back to FIG. 1, once image segments have been selected for searching via image segment determiner 114 of search engine 110, image searcher 116 may separately search the image segments to identify a separate set of search results for each selected image segment. The search results that are determined by image searcher 116 may be generated for display on a search results page by search results page generator 118.

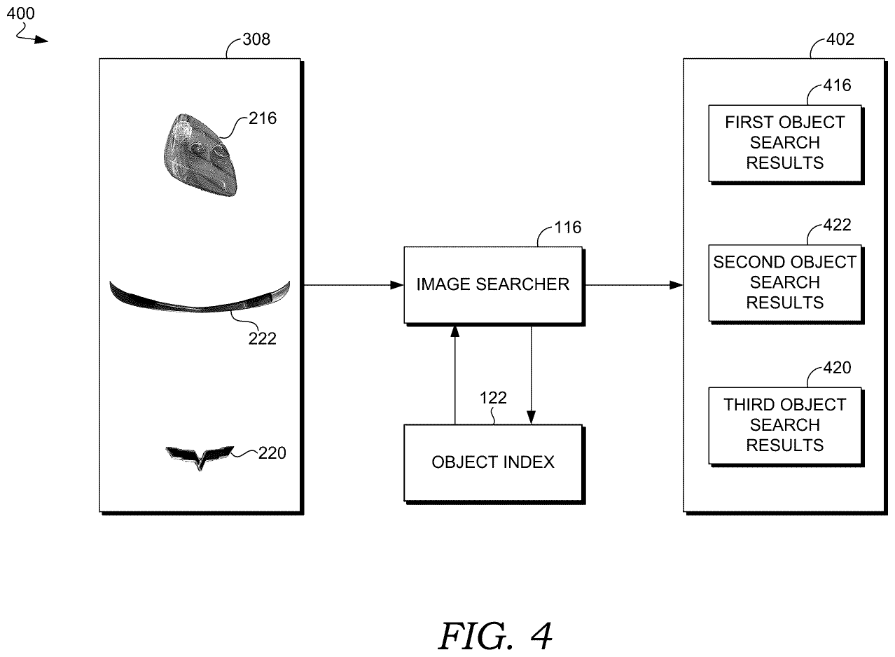

With reference now to FIG. 4, FIG. 4 illustrates an example 400 of separately searching the selected image segments 308 (e.g., from FIG. 3) from image segment determiner 114. In some aspects, image searcher 116 may reference object index 122 to perform a separate database search (e.g., a separate reverse image search). As an example, object index 122 may comprise items represented in a search space, such as a vector space, and may be used to identify items to return as search results. As an example, object index 122 may include vector representations of images corresponding to items. Image searcher 116 may execute a search for an item by determining a vector representation of each of image segments 308, and separately returning a set of search results for each image segment based on the image segment vector relative to image vectors within object index 122.

For instance, image searcher 116 may reference object index 122 to perform a separate database search for first image segment 216, second image segment 222, and third image segment 220 to identify a separate set of search results for the first image segment 216, second image segment 222, and third image segment 220. By performing separate database searches on each of the selected image segments, image searcher 116 individually reverse image searches the selected image segments to find similar images of objects in object index 122 corresponding to the selected image segments. For example, if a selected image segment includes a wheel of a car (e.g., the object that identifies the image segment), then image searcher 116 would reverse image search the image segment of the wheel to identify a set of search results including other images of wheels in object index 122.

In some aspects, in performing a separate database search for each image segment 206, image searcher 116 determines which of the selected image segments have at least one corresponding match to search engine's 110 database. In at least one aspect, search engine 110 maintains an extensive database of web pages, other online content, and/or stored information, and image searcher 116 queries this database with each selected image segment to determine if any matching results exist. Accordingly, image searcher 116 utilizes similarity queries for each image segment (e.g., first image segment 216, second image segment 222, and third image segment 220. If there is nothing in the search engine's 110 database corresponding to any of the selected image segments, then those image segments are filtered out, meaning that they will not be used to generate search results. As such, image searcher 116 may use each image segment 206 to query search engine's 110 database to determine if there are potential search results in the database that match any of the image segments.

Furthermore, in some aspects, image searcher 116 may cause server 102 or client device 104 to display (e.g., via a GUI) the image segments that have at least one matching result stored in the search engine's 110 database. In displaying the image segments that have at least one corresponding result, image searcher 116 may allow users to select which image segments that the user wants to receive search results for. As such, in at least one aspect, users may be able to select a portion of the image segments identified from the input image for searching. For example, the image segments identified within the image may be presented at a display, and the user may select one or more of the image segments from a portion of identified image segments provided for display.

One method for separately reverse image searching an image segment to identify a set of search results that can be employed by image searcher 116 includes ranking. For example, search engine 110 may rank the search results based on similarity metrics. That is, image searcher 116 may use ranking algorithms to sort the search results based on various factors such as relevance, page quality, rating, and user feedback, among others. For example, as can be seen in the example illustrated in FIG. 4, the first image segment 216 may be separately reversed image searched (e.g., searched in isolation, without reverse image searching the second image segment 222 or the third image segment 220) by image searcher 116 to identify first object search results 416. In at least one aspect, first object search results 416 includes a top ranked search result for the first image segment 216. In some aspects, first object search results 416 may include a second ranked search result, a third ranked search result, and/or other lower ranked search results for the first image segment 216. By employing search and ranking algorithms, image searcher 116 increases the likelihood of finding relevant information (e.g., more accurate search results) to assist search engine 110 in responding to the initial user query.

Continuing with this example, to identify first object search results 416, image searcher 116 employs any method of ranking (e.g., stack ranking; forced ranking; agile prioritization techniques; pointwise, pairwise, and listwise ranking; etc.) to rank a set of search results for the first image segment 216 obtained using object index 122. For example, if 10 search results were identified in object index 122 for the first image segment 216, image searcher 116 may rank the each search result in the set of search results from 1-10, or a portion thereof. Thus, image searcher 116 identifies a set of search results located in the object index 122 and may rank each search result in the set of search results for each selected image segment.

For instance, image searcher 116 may identify a set of search results for the second image segment 222 and employ a ranking method to determine second object search results 422, and image searcher 116 may identify a set of search results for the third image segment 220 and employ a ranking method to determine third object search results 420. As can be seen in box 402 of FIG. 4, the selected image segments (first image segment 216, second image segment 222, and third image segment 220) each have a corresponding set of search results (e.g., first object search results 416, second object search results 422, and third object search results 420). In some examples, first object search results 416, second object search results 422, and third object search results 420 may comprise any number of search results (e.g., 2, 5, 17, 35, etc.). For example, first object search results 416 may have 11 search results associated with headlights, second object search results 422 may have 13 search results associated with fenders, and third object search results 420 may have 12 search results associated with emblems. In some examples, each set of search results (e.g., first object search results 416, second object search results 422, and third object search results 422) may each comprise the same number of search results. According to aspects, each set of search results may be used by search results page generator 118 to generate search results pages.

To highlight a technical benefit, by performing separate database searches for each identified object in an input image, search engine 110 improves traditional search engines. For example, while conventional search engines often only search a single object from an input image and display search results related to that object, the search engine of the present disclosure may perform separate database searches on each identified image segment to identify a set of search results for each image segment. In this way, more search results may be identified and displayed, providing a variety of search results that includes multiple objects instead of a single object.

In other words, the image searcher 116 may use a first reverse image search (e.g., a first database search) to identify a plurality of search results for each of a first object and a second object, and the first search result may be identified based on the first search result being a top ranked search result among the plurality of search results for the first object, and the second search result may be identified based on the second search result being a top ranked search result among the plurality of search results for the second object. Furthermore, a second reverse image search (e.g., a second database search) may be performed for each of the first image segment and the second image segment, and a second ranked search result may be identified among the plurality of search results for the first object and a second ranked search result may be identified among the plurality of search results for the second object based on the second database search. By showing a first item from a first search (e.g., a first search result) and a second item from a second different search (e.g., a second search result) on the same search results page, the number of page loads by the computer is reduced, since the computer may not be required to load a different search results page for search results related to a different item.

Moreover, by searching multiple image segments of an image in the same operation, search engine 110 may decrease computational costs. For example, when a traditional search engine searches a single object in an image, a user may need to run a subsequent search (e.g., either image- or text-based) to receive search results that better match the intent on the user in submitting the original query. For instance, traditional search engines perform a search and display search results for that particular search. When a second separate search is performed, new search results for the second search are loaded. However, by performing separates searches and displaying the results of separate searches on the same page, the number of pages loaded is reduced. Further, more accurate search results can be efficiently identified and returned, thereby lowering the number of searches that a user submits to the search engine. Based on this, search engine 110 receives fewer queries, since users are more likely to be provided and find the search results relevant to their initial query. Accordingly, there is more computational processing power available for search engine 110 to perform other tasks.

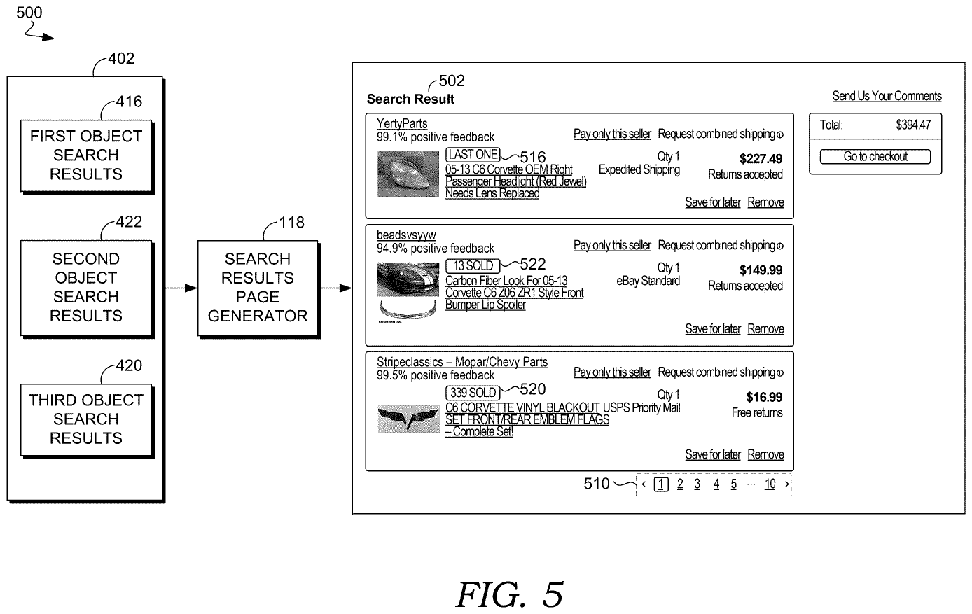

Turning now to FIG. 5, FIG. 5 depicts an example generated search results page 500. The example generated search results page 500 is generated by search results page generator 118 utilizing the sets of search results received from image searcher 116. For example, search results page generator 118 may display the search results on a search results page (e.g., search result 502) as a group of search results (e.g., two or more search results corresponding to the selected image segments that were separately searched with image searcher 116). Each group of search results may be a set of combined search results that includes at least one search result for each image segment.

Thus, search results page generator 118 may generate a search results page having one or more search results selected from each separate search of the image segments. For example, search results page generator 118 may utilize first object search results 416 (e.g., corresponding to the first image segment 216), second object search results 422 (e.g., corresponding to the second image segment 222), and third object search results 420 (e.g., corresponding to the third image segment 220) to generate one or more search results pages. As such, one or more search results for the first image segment 216, one or more search results for the second image segment 222, and one or more search results for the third image segment 220 may be displayed on a single search results page or on multiple search results pages. For example, first search result 516 corresponds to one of the search results selected from the first object search results 416, second search result 522 corresponds to one of the search results selected from the second object search results 422, and third search result 520 corresponds to one of the search results selected from the third object search results 420.

According to aspects, the search results page generator 118 may generate multiple search results pages. For example, as indicated by hyperlinks 510, the search results page generator 118 generated 10 search results pages for the first object search results 416, the second object search results 422, and the third object search results 420. Each of the hyperlinks 510, illustrated numerically, navigates to a different search results page. In some aspects, each search result page generated by search results page generator 118 includes at least one search result for the set of search results corresponding to each selected image segments that was separately searched with image searcher 116. By displaying search results for separate image segments on the same page as a group of search results, search engine 110 may decrease page load times due to the conciseness of the search results being displayed. Further, overall system latency may be reduced, as the reduction in the response time experienced from fewer transmitted search results (e.g., more concise search results) allows for faster processing of each user query.

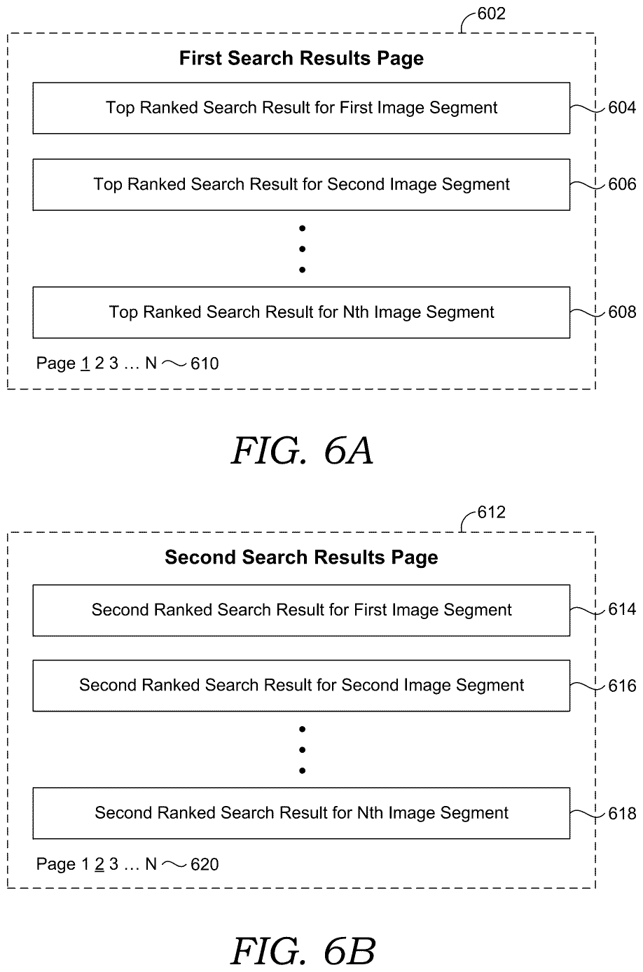

In accordance with one example, FIGS. 6A and 6B each depict search results pages that may be generated by search results page generator 118. For example, search results page generator 118 may generate first search results page 602 (e.g., as depicted in FIG. 6A) and second search results page (e.g., as depicted in FIG. 6B). In some aspects, the first search results page 602 may display the top ranked search results for each selected image segment. For example, the first search results page 602 may include top ranked search result for first image segment 604, top ranked search result for second image segment 606, and any top ranked search result for a selected image segment until reaching top ranked search result for Nth image segment 608. The first search results page 602 may be indicated to a user as a first selected hyperlink 610. Moreover, at the first search results page 602, a hyperlink may be provided to the second search results page 612. In some cases, while the first search results page may have the top ranked search results for each image segment (e.g., the top ranked search result for the object in each image segment), the second search results page may have the second ranked search result for each image segment (e.g., the second ranked search result for each object in each image segment).

Furthermore, in some aspects, the second search results page 612 may be hyperlinked at the first search results page 602 and may include the second ranked search results for each selected image segment. For example, the second search results page 612 may include second ranked search result for first image segment 614, second ranked search result for second image segment 616, and any second ranked search result for a selected image segment until reaching second ranked search result for Nth image segment 618. The second search results page 612 may be indicated to a user as a second selected hyperlink 620. In at least one embodiment, a user may click on any of the hyperlinks depicting the number of the page, and the user may be directed to the page that is clicked, which may contain a group of search results on a search results page generated by search results page generator 118.

This approach of displaying the search results on a search results page as a group of search results including two or more search results is a technical improvement of the conventional displaying method of traditional search engines. For instance, by displaying a group of search results corresponding to each searched image segment solves the issues associated with displaying search results in a plain list. For example, in accordance with aspects of the disclosed search engine 110, if a user uploads an image of a car, and the user wants to see search results for both a windshield and a windshield wiper, the search results page generated by the search results page generator 118 may display search results including both windshield wipers and windshields displayed together on the same search results page. Thus, search engine 110 may return search results for both a windshield and a windshield wiper, which previously may not have been identified and/or returned using a traditional search engine.

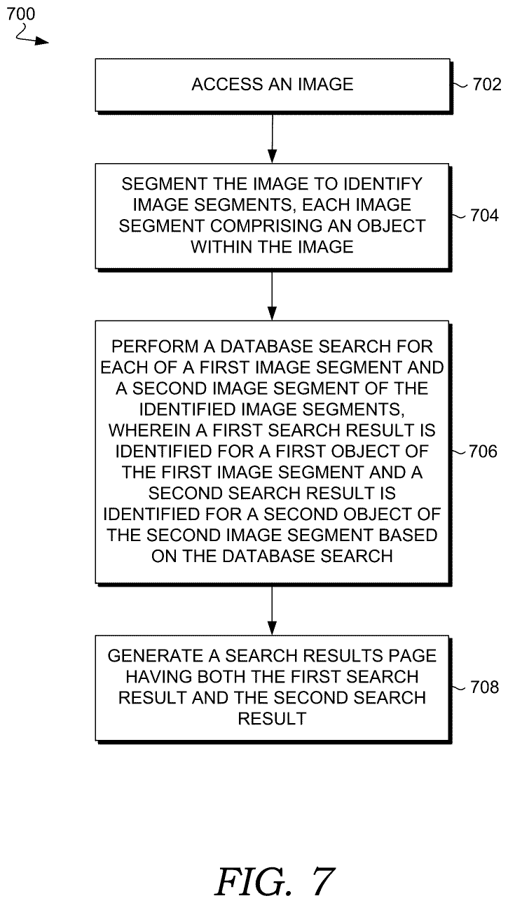

With reference to FIGS. 7-9, block diagrams are provided to illustrate methods for separately searching a plurality of image segments in an image and displaying search results for each image segment on the same search results page. The methods may be performed using search engine 110 of FIG. 1 and related components. In embodiments, one or more computer storage media having computer-executable instructions embodied thereon that, when executed, by one or more processors, cause the one or more processors to perform the methods for providing search results.

Initially referring to FIG. 7, an example method 700 for separately searching a plurality of image segments in an image and displaying search results for each image segment on the same search results page. At block 702, an image is accessed. This can be performed by search engine 110 of FIG. 1. That is, when an image-based query is received, the image itself is accessed by the search engine. For instance, if a user submits an image of a car to the search engine, that image is accessed by the search engine for further processing.

At block 704, the image is segmented to identify image segments, and each image segment comprises an object in the image. This can be performed by image segmentation engine 112 of FIG. 1. For instance, any image segmentation technique can be used to segment the image accessed at block 702. The image can be divided into smaller segments using an object recognition model. The object recognition model may identify specific objects in the input image. By using an object recognition model to identify objects in the image, image segments may be extracted having those objects. Each image segment may be a portion of the input image and includes the object that identifies the image segment

At block 706, a database search is performed for each of a first image segment and a second image segment of the identified image segments. For example, each image segment identified and extracted at block 704 may be used to perform a database search. A separate database search may be performed for each image segment.

Still at block 706, a first search result is identified for a first object of the first image segment and a second search result may be identified for a second object of the second image segment based on the database search. This may be performed by image searcher 116 of FIG. 1. For instance, each image segment may be separately searched to identify a separate set of search results for each selected image segment. Accordingly, a set of search results may be identified for the object in the first image segment and another set of search results may be identified for the object in the second image segment. To do this, an object index may be referenced while performing separate database searches for the object in the first image segment and the object in the second image segment.

At block 708, a search results page is generated having both the first search result and the second search result. This may be performed by search results page generator 118 of FIG. 1. For instance, the set of search results identified for the first image segment and the set of search results identified for the second image segment at block 706 may be used to generate a search results page containing both the first search result and the second search result. Thus, the first search result and the second search result may be displayed on the same search results page. According to some aspects, multiple search result pages may be generated containing a search result for the first image segment and a search result for the second image segment.

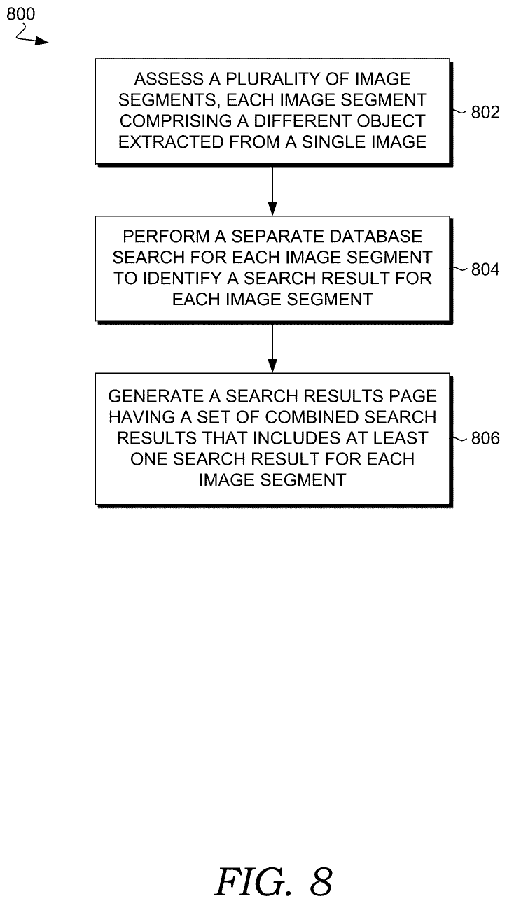

Referring now to FIG. 8, an example method 800 for separately searching a plurality of image segments in an image and displaying search results for each image segment on the same search results page. At block 802, a plurality of image segments is identified, and each image segment comprises a different object extracted from a single image. In some examples, the image segmentation engine 112 of FIG. 1 may identify the plurality of image segments based on the objects in the image

At block 804, a separate database search for each image segment is performed to identify a search result for each image segment. This can be performed by image searcher 116 of FIG. 1. For instance, the separate database search is performed on each image segment by individually reverse image searching each image segment to find similar objects in an object index and identify search results in the object index. The search results may be ranked based on similarity metrics. Each set of search results for each image segment may be used by to generate search results pages.

At block 806, a search results page is generated having a set of combined search results that includes at least one search result for each image segment. This may be performed by search results page generator 118 of FIG. 1. For instance, a search results page may be generated that displays a search result for each image segment identified in block 804.

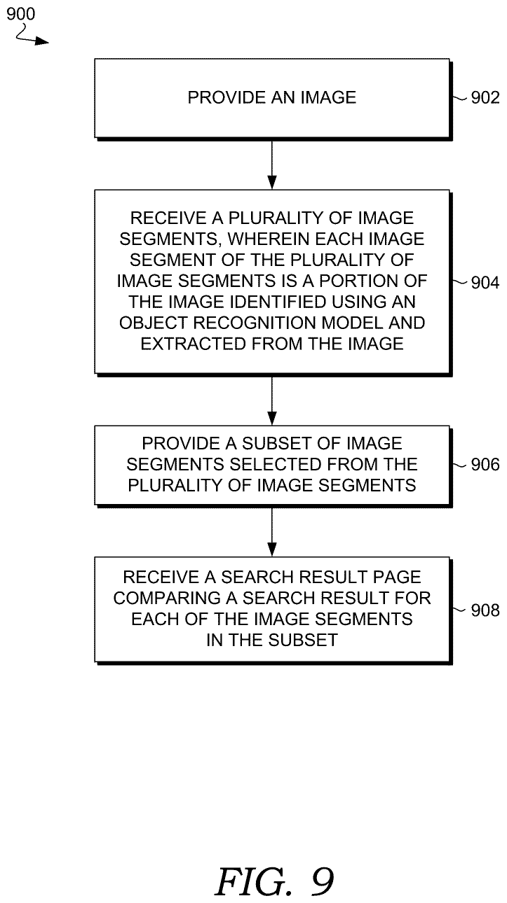

Referring now to FIG. 9, an example method 900 for separately searching a plurality of image segments in an image and displaying search results for each image segment on the same search results page. At block 902, an image is provide. The image can be provided by client device 104 of FIG. 1. For instance, an image-based query can be provided by the computing device to the search engine.

At block 904, a plurality of image segments is received, and each image segment of the plurality of image segments is a portion of the image identified using an object recognition model and extracted from the image. This may be performed by image segmentation engine 112 of FIG. 1. The image can be divided into smaller segments using an object recognition model. The object recognition model may identify specific objects in the input image. By using an object recognition model to identify objects in the image, image segments may be extracted having those objects. Each image segment may be a portion of the input image and includes the object that identifies the image segment.

At block 906, a subset of image segments selected from the plurality of image segments is provided. This can be performed by image searcher 116 of FIG. 1. For example, a subset of image segments may be determined based on the objects in each image segment, the subset of image segments may be ranked, and the ranked subset of image segments may be provided to a search results page generator.

At block 908, a search results page is received comparing a search result for each of the image segments in the subset. This may be performed by search results page generator 118 of FIG. 1. For example, a search results page can be generated that contains the search results, and this search results page can be provided to a client device for display via a GPU.

Having described an overview of embodiments of the present technology, an example operating environment in which embodiments of the present technology may be implemented is described below in order to provide a general context for various aspects. Referring initially to FIG. 10, in particular, an example operating environment for implementing embodiments of the present technology is shown and designated generally as computing device 1000. Computing device 1000 is but one example of a suitable computing environment and is not intended to suggest any limitation as to the scope of use or functionality of the technology. Neither should computing device 1000 be interpreted as having any dependency or requirement relating to any one or combination of components illustrated.

The technology of the present disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technology may be practiced in a variety of system configurations, including hand-held devices, consumer electronics, general-purpose computers, more specialty computing devices, etc. The technology may also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output ports 1018, input/output components 1020, and illustrative power supply 1022. Bus 1010 represents what may be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one may consider a presentation component, such as a display device, to be an I/O component. As another example, processors may also have memory. Such is the nature of the art, and it is again reiterated that the diagram of FIG. 10 merely illustrates an example computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, and removable and non-removable media. By way of example, and not limitation, computer-readable media may comprise computer storage media and communication media.

Computer storage media include volatile and nonvolatile, removable and non-removable media implemented in any method or technology for storage of information, such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1012 includes computer storage media in the form of volatile or nonvolatile memory. The memory may be removable, non-removable, or a combination thereof. Example hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Examples of presentation components include a display device, speaker, printing component, vibrating component, etc.

I/O ports 1018 allow computing device 1000 to be logically coupled to other devices including I/O components 1020, some of which may be built in. Illustrative components include a microphone, joystick, game pad, satellite dish, scanner, printer, wireless device, and so forth.

Embodiments described above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of the present technology is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” or “block” might be used herein to connote different elements of methods employed, the terms should not be interpreted as implying any particular order among or between various steps herein disclosed unless and except when the order of individual steps is explicitly stated.

For purposes of this disclosure, the word “including” or “having” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media. Also, the word “initiating” has the same broad meaning as the word “executing or “instructing” where the corresponding action can be performed to completion or interrupted based on an occurrence of another action.

In addition, words such as “a” and “an,” unless otherwise indicated to the contrary, include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely an example. Components can be configured for performing novel aspects of embodiments, where the term “configured for” or “configured to” can refer to “programmed to” perform particular tasks or implement particular abstract data types using code. Further, while embodiments of the present technology may generally refer to returning search results, it is understood that the techniques described may be extended to other implementation contexts.

From the foregoing, it will be seen that this technology is one well adapted to attain all the ends and objects described above, including other advantages that are obvious or inherent to the structure. It will be understood that certain features and subcombinations are of utility and may be employed without reference to other features and subcombinations. This is contemplated by and is within the scope of the claims. Since many possible embodiments of the described technology may be made without departing from the scope, it is to be understood that all matter described herein or illustrated in the accompanying drawings is to be interpreted as illustrative and not in a limiting sense.

Some example aspects that may be practiced from the forgoing description include:

Aspect 1: A method performed by one or more processors, the method comprising: accessing an image; segmenting the image to identify image segments, each image segment comprising an object within the image; performing a database search for each of a first image segment and a second image segment of the identified image segments, wherein a first search result is identified for a first object of the first image segment and a second search result is identified for a second object of the second image segment based on the database search; and generating a first search results page (SRP) having both the first search result and the second search result.

Aspect 2: Aspect 1, further comprising providing at least a portion of the identified image segments for display at a computing device; and receiving a selection of image segments from the portion of identified image segments provided for display, the selection comprising the first image segment and the second image segment, wherein the database search is performed for each image segment of the selection.

Aspect 3: Any of Aspects 1-2, wherein identifying image segments is based on the object in the image segment using an object recognition model.

Aspect 4: Any of Aspects 1-3, wherein the database search is a separate reverse image search for each of the first image segment having the first object and the second image segment having the second object.

Aspect 5: Any of Aspects 1-4, wherein the first image segment comprises the second image segment.

Aspect 6: Any of Aspects 1-5, further comprising identifying a plurality of search results for each of the first object and the second object, wherein the first search result is identified based on the first search result being a top ranked search result among the plurality of search results for the first object, and wherein the second search result is identified based on the second search result being a top ranked search result among the plurality of search results for the second object.

Aspect 7: Any of Aspects 1-6, further comprising performing a second database search for each of the first image segment and the second image segment, wherein a second ranked search result is identified among the plurality of search results for the first object and a second ranked search result is identified among the plurality of search results for the second object based on the second database search; and providing, at the first SRP, a hyperlink to a second SRP, the second SRP having both the second ranked search result for the first object and the second ranked search result for the second object.

Aspect 8: One or more computer storage media having computer-executable instructions embodied thereon that, when executed by one or more processors, cause the one or more processors to perform operations comprising: accessing a plurality of image segments, each image segment comprising a different object extracted from a single image; performing a separate database search for each image segment to identify a search result for each image segment; and generating a first search results page (SRP) having a set of combined search results that includes at least one search result for each image segment.

Aspect 9: Aspect 8, wherein the separate database searches comprises performing a reverse image search for each image segment.

Aspect 10: Any of Aspects 8-9, further comprising identifying each image segment based on the object in the image segment using an object recognition model.

Aspect 11: Any of Aspects 8-10, further comprising providing each image segment for display at a computing device; and receiving a selection of image segments provided for display, the selection comprising a first image segment and a second image segment, wherein the separate database search is performed for each of the first image segment and the second image segment.

Aspect 12: Any of Aspects 8-11, wherein the first image segment comprises the second image segment.

Aspect 13: Any of Aspects 8-12, further comprising identifying the set of combined search results that includes the at least one search result for each image segment, wherein a first search result is identified based on the first search result being a top ranked result among a plurality of search results for the first image segment, wherein a second search result is identified based on the second search result being a top ranked search result among a plurality of search results for the second image segment, and wherein the set of combined search results includes the first search result and the second search result.

Aspect 14: Any of Aspects 8-13, further comprising providing, at the first SRP, a hyperlink to a second SRP, the second SRP having both a second ranked search result for the first image segment and a second ranked search result for the second image segment.

Aspect 15: A system comprising: at least one processor; and one or more computer storage media storing computer readable instructions thereon that when executed by the at least one processor cause the at least one processor to perform operations comprising: providing an image; receiving a plurality of image segments, wherein each image segment of the plurality of image segments is a portion of the image identified using an object recognition model and extracted from the image; providing a subset of image segments selected from the plurality of image segments; and receiving a first search results page (SRP) comprising a search result for each of the image segments in the subset.

Aspect 16: Aspect 15, wherein the search result for each of the image segments in the subset is determined from a separate reverse image search for each of the image segments.

Aspect 17: Any of Aspects 15-16, wherein a first reverse image search identifies a first search result for a first image segment and a second reverse image search identifies a second search result for a second image segment, the first SRP comprising the first search result and the second search result.

Aspect 18: Any of Aspects 15-17, wherein the first search result is a top ranked search result among a plurality of search results for the first image segment and the second search result is a top ranked search result among a plurality of search results for the second image segment.

Aspect 19: Any of Aspects 15-18, wherein the first image segment comprises the second image segment.

Aspect 20: Any of Aspects 15-19, further comprising receiving an input at a hyperlink to a second SRP that is provided at the first SRP, the second SRP having both a second ranked search result for the first image segment and a second ranked search result for the second image segment.

What is claimed is:

1. A method performed by one or more processors, the method comprising:
accessing an image;
segmenting the image to identify image segments, each image segment comprising an object within the image;
performing a database search for each of a first image segment and a second image segment of the identified image segments, wherein a first search result is identified for a first object of the first image segment and a second search result is identified for a second object of the second image segment based on the database search; and
generating a first search results page (SRP) having both the first search result and the second search result.

2. The method of claim 1, further comprising:
providing at least a portion of the identified image segments for display at a computing device; and
receiving a selection of image segments from the portion of identified image segments provided for display, the selection comprising the first image segment and the second image segment, wherein the database search is performed for each image segment of the selection.

3. The method of claim 1, wherein identifying image segments is based on the object in the image segment using an object recognition model.

4. The method of claim 1, wherein the database search is a separate reverse image search for each of the first image segment having the first object and the second image segment having the second object.

5. The method of claim 1, wherein the first image segment comprises the second image segment.

6. The method of claim 1, further comprising identifying a plurality of search results for each of the first object and the second object, wherein the first search result is identified based on the first search result being a top ranked search result among the plurality of search results for the first object, and wherein the second search result is identified based on the second search result being a top ranked search result among the plurality of search results for the second object.

7. The method of claim 6, further comprising:
performing a second database search for each of the first image segment and the second image segment, wherein a second ranked search result is identified among the plurality of search results for the first object and a second ranked search result is identified among the plurality of search results for the second object based on the second database search; and
providing, at the first SRP, a hyperlink to a second SRP, the second SRP having both the second ranked search result for the first object and the second ranked search result for the second object.

8. One or more computer storage media having computer-executable instructions embodied thereon that, when executed by one or more processors, cause the one or more processors to perform operations comprising:
accessing a plurality of image segments, each image segment comprising a different object extracted from a single image;
performing a separate database search for each image segment to identify a search result for each image segment; and
generating a first search results page (SRP) having a set of combined search results that includes at least one search result for each image segment.

9. The one or more computer storage media of claim 8, wherein performing the separate database searches comprises performing a reverse image search for each image segment.

10. The one or more computer storage media of claim 8, further comprising identifying each image segment based on the object in the image segment using an object recognition model.

11. The one or more computer storage media of claim 8, further comprising:
providing each image segment for display at a computing device; and
receiving a selection of image segments provided for display, the selection comprising a first image segment and a second image segment, wherein the separate database search is performed for each of the first image segment and the second image segment.

12. The one or more computer storage media of claim 11, wherein the first image segment comprises the second image segment.

13. The one or more computer storage media of claim 11, further comprising identifying the set of combined search results that includes the at least one search result for each image segment, wherein a first search result is identified based on the first search result being a top ranked result among a plurality of search results for the first image segment, wherein a second search result is identified based on the second search result being a top ranked search result among a plurality of search results for the second image segment, and wherein the set of combined search results includes the first search result and the second search result.

14. The one or more computer storage media of claim 12, further comprising providing, at the first SRP, a hyperlink to a second SRP, the second SRP having both a second ranked search result for the first image segment and a second ranked search result for the second image segment.

15. A system comprising:
at least one processor; and
one or more computer storage media storing computer readable instructions thereon that when executed by the at least one processor cause the at least one processor to perform operations comprising:
providing an image;
receiving a plurality of image segments, wherein each image segment of the plurality of image segments is a portion of the image identified using an object recognition model and extracted from the image;
providing a subset of image segments selected from the plurality of image segments; and
receiving a first search results page (SRP) comprising a search result for each of the image segments in the subset.

16. The system of claim 15, wherein the search result for each of the image segments in the subset is determined from a separate reverse image search for each of the image segments.

17. The system of claim 16, wherein a first reverse image search identifies a first search result for a first image segment and a second reverse image search identifies a second search result for a second image segment, the first SRP comprising the first search result and the second search result.

18. The system of claim 17, wherein the first search result is a top ranked search result among a plurality of search results for the first image segment and the second search result is a top ranked search result among a plurality of search results for the second image segment.

19. The system of claim 18, wherein the first image segment comprises the second image segment.

20. The system of claim 18, further comprising receiving an input at a hyperlink to a second SRP that is provided at the first SRP, the second SRP having both a second ranked search result for the first image segment and a second ranked search result for the second image segment.
